(19) United States
(12) Patent Application Publication
(10) Pub. No.: US 2026/0301736 A1
(43) Pub. Date: Oct. 1, 2026

(54) NATURAL LANGUAGE-DRIVEN DEVICE AUTOMATION SYSTEMS AND METHODS

(71) Applicant: Boost SubscriberCo L.L.C., Englewood, CO (US)

(72) Inventors: Levi Eichelberg, Englewood, CO (US); Joshua DeLaTorre, Englewood, CO (US); Rohit Singh, Littleton, CO (US)

(21) Appl. No.: 19/090,083

(22) Filed: Mar. 25, 2025

(51) Int. Cl. G10L 15/183; G10L 15/22

(52) U.S. Cl. CPC G10L 15/183; G10L 15/22; G10L 2015/223

(57) ABSTRACT

A disclosed method may include (i) receiving, through a software automation tool, a natural language input from a user describing a goal that the user seeks to accomplish on a computing device and (ii) dividing, by the software automation tool in response to receiving the natural language input from the user, the goal into a sequence of plural steps that the software automation tool predicts would achieve the goal.

### BRIEF SUMMARY

This disclosure is generally directed to systems, methods, and computer-readable media relating to natural language-drive device automation. In the realm of device automation, users may encounter various challenges when attempting to perform complex tasks or navigate intricate user interfaces. These difficulties may arise from the diverse range of devices and applications available, each with its own unique interface and set of commands. A user may find it challenging to remember specific steps or locate particular features within an application, especially when dealing with infrequently used functions or newly updated interfaces. This may lead to frustration and reduced productivity as users spend time searching for the correct sequence of actions to achieve their desired outcomes. Additionally, users with limited technical expertise may struggle to understand and execute multi-step processes, potentially limiting their ability to fully utilize their devices' capabilities. The complexity of modern devices and applications may also contribute to a steep learning curve for new users, who may feel overwhelmed by the multitude of options and settings available to them. Furthermore, individuals with disabilities or those who prefer alternative input methods may face additional barriers when interacting with traditional user interfaces, which may not always be designed with accessibility in mind. These challenges may collectively result in a suboptimal user experience, potentially leading to underutilization of device features and a general sense of frustration or dissatisfaction with technology.

To address these challenges, a natural language-driven device automation system may be employed. This technique may allow users to interact with their devices using everyday language, potentially eliminating the need to memorize specific commands or navigate complex menu structures. By interpreting natural language inputs, the system may break down user requests into a series of actionable steps, which may then be executed automatically on the device. This technique may significantly reduce the cognitive load on users, allowing them to focus on their intended goals rather than the minutiae of device operation. Furthermore, this technique may provide a more intuitive and user-friendly experience, potentially making advanced device features more accessible to a wider range of users, including those with limited technical knowledge or experience. The natural language interface may also offer benefits in terms of accessibility, as it may accommodate various input methods such as voice commands or text input, potentially making device interaction more inclusive for users with diverse abilities. Additionally, the system's ability to understand context and intent may allow for more flexible and forgiving interactions, as users may not need to use exact terminology or follow rigid command structures to achieve their desired outcomes. This flexibility may lead to a more natural and conversational interaction style, which may feel more comfortable and less intimidating for many users. Moreover, the automation aspect of the system may streamline repetitive or complex tasks, potentially saving time and reducing the likelihood of user errors in multi-step processes.

One of the challenges in implementing such a system may be the dynamic nature of user interfaces across different devices and applications. User interfaces may change frequently due to software updates, device-specific variations, or customized settings. A static automation technique may become obsolete quickly, and may involve constant updates to maintain functionality. To overcome this issue, a dynamic feedback loop may be incorporated into the automation system. This technique may involve capturing the current user interface layout after each action, analyzing it, and adjusting subsequent steps accordingly. By continuously adapting to the current state of the interface, the system may maintain its effectiveness even in the face of UI changes or variations across different devices. This adaptive technique may also help in handling unexpected pop-ups, error messages, or other dynamic elements that may appear during the execution of a task. The system may analyze these elements in real-time and determine appropriate responses, potentially mimicking the decision-making process of a human user. Furthermore, this dynamic adaptation may extend to different versions of the same application across various devices or operating systems, allowing the automation system to function consistently regardless of the specific device or platform being used. This flexibility may be particularly valuable in environments where users frequently switch between devices or in organizations with diverse technology ecosystems. The continuous feedback loop may also serve as a learning mechanism for the system, potentially enabling it to improve its performance over time by recognizing patterns in UI layouts and user behaviors across different applications and devices.

Another potential challenge in device automation may be the handling of unexpected scenarios or errors that may occur during the execution of a task. Traditional scripted automation techniques may fail when encountering unforeseen situations, thereby involving manual intervention or resulting in incomplete tasks. To address this issue, the natural language-driven automation system may employ a large language model (LLM) capable of understanding context and generating alternative solutions. When faced with an unexpected UI element or error step, the LLM may analyze the situation and attempt to formulate a new course of action. This adaptive problem-solving capability may enhance the system's robustness and reliability, potentially reducing the need for user intervention in complex or unusual scenarios. The LLM's ability to understand and generate human-like text may also allow it to interpret error messages or prompts in a more nuanced way, potentially enabling more appropriate responses to system feedback. Additionally, the LLM may be capable of learning from past interactions and outcomes, gradually improving its ability to handle edge cases and unusual situations over time. This learning capability may result in a system that becomes increasingly adept at navigating complex or rarely encountered scenarios, potentially offering a level of reliability and adaptability that surpasses other rule-based automation systems. Furthermore, the LLM's natural language processing capabilities may allow it to generate helpful explanations or suggestions for users when it encounters situations it cannot fully resolve autonomously, potentially providing a more transparent and user-friendly experience even in challenging circumstances.

In some examples, a method includes (i) receiving, through a software automation tool, a natural language input from a user describing a goal that the user seeks to accomplish on a computing device, (ii) dividing, by the software automation tool in response to receiving the natural language input from the user, the goal into a sequence of plural steps that the software automation tool predicts would achieve the goal, (iii) performing, for each respective step of the sequence of plural steps in sequential order, a looping algorithm that provides an iterative capture of a current user interface (UI) layout of the computing device to a large language model (LLM) in a loop until the respective step is completed, and (iv) outputting, through the software automation tool to the user and based on performing the looping algorithm for each respective step of the sequence of plural steps in sequential order, an indication that the goal has been achieved for the user in response to receiving the natural language input.

In some examples, the looping algorithm comprises: setting a next action as the respective step, attempting, as an attempt operation, to perform the next action, capturing, as a capturing operation in response to attempting to perform the next action, a current user interface (UI) layout of the computing device, providing, as a providing operation, the current UI layout to the LLM, receiving, as a receiving operation, from the LLM, an indication that the next action succeeded or that the next action failed such that a new intervening troubleshooting action should be performed, and repeating, if the LLM indicates that the next action failed, the attempt operation, the capturing operation, the providing operation, and the receiving operation using the new intervening troubleshooting action as the next action until the LLM indicates that the respective step succeeded.

In some examples, the providing operation comprises compressing the current UI layout such that a compressed UI layout is provided to the LLM.

In some examples, dividing the goal into the sequence of plural steps is performed by the LLM.

In some examples, the method further comprises updating a memory of the LLM based on successful completion of the goal such that the LLM learns from a previous interaction.

In some examples, the next action comprises, for at least one iteration, a series of plural actions for execution in series or parallel without intervening feedback between any two of the plural actions.

In some examples, the capturing operation comprises applying a UI automation framework such that structured text representing the UI layout is extracted.

In some examples, attempting to perform the next action comprises simulating user input on the computing device.

In some examples, the looping algorithm further comprises verifying that the current UI layout has changed before providing the current UI layout to the LLM.

In some examples, the method further comprises capturing and processing an image of the current UI layout if the looping algorithm fails to progress after a predetermined number of iterations.

In some examples, the computing device comprises a mobile device, a desktop computer, a smart TV, or a wearable device.

In some examples, the method further comprises initiating a timeout procedure if the looping algorithm exceeds a predetermined duration or a predetermined number of iterations for a particular operation.

In some examples, the method further comprises detecting that the looping algorithm is stuck at a current step and requesting, in response to detecting that the looping algorithm is stuck at the current step, user guidance for completing the current step.

In some examples, the method further comprises generating a report detailing the sequence of plural steps performed or at least one error encountered during execution of the sequence of plural steps.

In some examples, the method further comprises receiving the natural language input as a voice command and converting the voice command into text before dividing the goal into the sequence of plural steps.

In some examples, the method further comprises maintaining a database of previously executed goals and their corresponding sequences of plural steps and dividing the goal into the sequence of plural steps is performed at least in part by referencing the database such that efficiency is improved.

In some examples, a non-transitory computer-readable medium has instructions stored thereon that, when executed by at least one physical computing processor, cause a computing device to perform operations comprising (i) receiving, through a software automation tool, a natural language input from a user describing a goal that the user seeks to accomplish on a computing device, (ii) dividing, by the software automation tool in response to receiving the natural language input from the user, the goal into a sequence of plural steps that the software automation tool predicts would achieve the goal, (iii) performing, for each respective step of the sequence of plural steps in sequential order, a looping algorithm that provides an iterative capture of a current user interface (UI) layout of the computing device to a large language model (LLM) in a loop until the respective step is completed, and (iv) outputting, through the software automation tool to the user and based on performing the looping algorithm for each respective step of the sequence of plural steps in sequential order, an indication that the goal has been achieved for the user in response to receiving the natural language input.

In some examples, a system comprises at least one physical computing processor of a computing device and a non-transitory computer-readable medium that has instructions stored thereon that, when executed by the at least one physical computing processor, cause the computing device to perform operations comprising (i) receiving, through a software automation tool, a natural language input from a user describing a goal that the user seeks to accomplish on a computing device, (ii) dividing, by the software automation tool in response to receiving the natural language input from the user, the goal into a sequence of plural steps that the software automation tool predicts would achieve the goal, (iii) performing, for each respective step of the sequence of plural steps in sequential order, a looping algorithm that provides an iterative capture of a current user interface (UI) layout of the computing device to a large language model (LLM) in a loop until the respective step is completed, and (iv) outputting, through the software automation tool to the user and based on performing the looping algorithm for each respective step of the sequence of plural steps in sequential order, an indication that the goal has been achieved for the user in response to receiving the natural language input.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to natural language-driven device automation.

FIG. 2 illustrates an example simplified process of how a software automation tool processes a natural language input to perform a series of actions on a smartphone.

FIG. 3 shows an example detailed breakdown of how a large language model (LLM) interprets a user's natural language input and breaks it down into subtasks.

FIG. 4 depicts an example process of executing the first step in a sequence of actions, including capturing and compressing a user interface (UI) layout.

FIG. 5 illustrates an example of how the LLM processes the compressed UI layout to determine the next action in the sequence.

FIG. 6 demonstrates example final steps in executing a user's request, including extracting the desired information from the UI layout.

FIG. 7 provides an example overview of the entire process flow, from receiving the user's natural language input to returning the requested information.

FIG. 8 presents an example detailed sequence diagram showing the interactions between various components of the system during the execution of a user's request.

FIG. 9 continues the sequence diagram from FIG. 8, illustrating an example of additional steps and error handling procedures.

FIG. 10 illustrates an example simplified process of how the software automation tool processes a natural language input to perform a series of actions on a smartphone.

FIG. 11 demonstrates an example application of the software automation tool to a smart TV, showing how the system handles a more complex request involving navigation through multiple menus.

FIG. 12 shows an example diagram of a computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

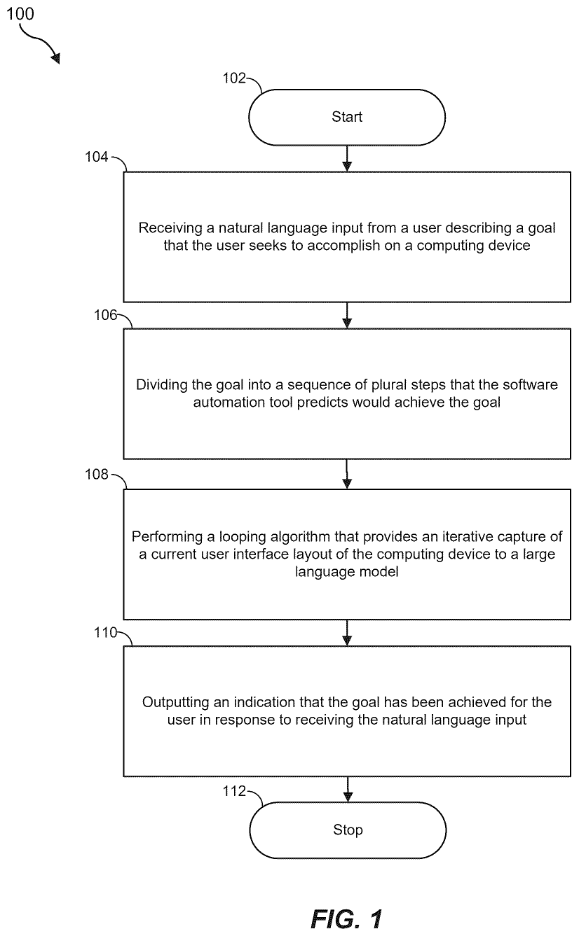

FIG. 1 shows a flow diagram for a method 100 relating to natural language-driven device automation. At step 102, method 100 may start. At step 104, method 100 includes receiving, through a software automation tool, a natural language input from a user describing a goal that the user seeks to accomplish on a computing device. At step 106, method 100 includes dividing, by the software automation tool in response to receiving the natural language input from the user, the goal into a sequence of plural steps that the software automation tool predicts would achieve the goal. At step 108, method 100 includes performing, for each respective step of the sequence of plural steps in sequential order, a looping algorithm that provides an iterative capture of a current user interface (UI) layout of the computing device to a large language model (LLM) in a loop until the respective step is completed. As used here, step 108 may be performed by capturing a single iterative capture in a scenario where the first attempt at the respective step of the plural steps is successful. At step 110, method 100 includes outputting, through the software automation tool to the user and based on performing the looping algorithm for each respective step of the sequence of plural steps in sequential order, an indication that the goal has been achieved for the user in response to receiving the natural language input. At step 112, method 100 ends.

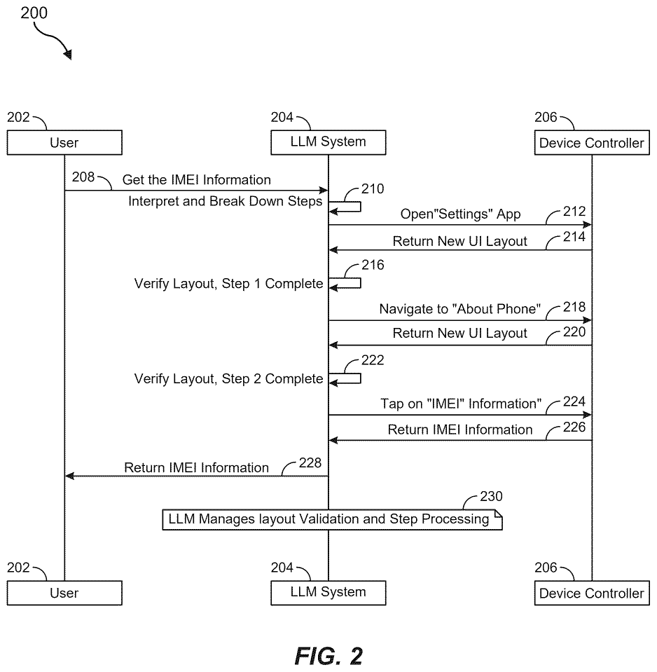

FIG. 2 illustrates a sequence diagram depicting the interactions between a user 202, a large language model (LLM) system 204, and a device controller 206 in a natural language-driven device automation process. This figure shows a high-level overview of how the system may interpret and execute a user's request, demonstrating the flow of information and actions between different components of the system. The sequence begins with the user 202 initiating the process by sending a natural language input, represented by step 208, to the LLM system 204. In this example, the user's request is to “Get the IMEI information” from a device. Upon receiving this input, the LLM system 204 may begin the task of interpreting and breaking down the user's request into actionable steps, as indicated by step 210. This step may involve the LLM system 204 analyzing the natural language input, understanding the context of the request, and formulating a plan to achieve the user's goal. The LLM system 204 may employ various natural language processing techniques to parse the input and identify the key components of the request. In some scenarios, the LLM system 204 may also access a database of previously executed tasks to inform its decision-making process and potentially improve the efficiency of the task breakdown.

Once the LLM system 204 has processed the request and determined the resulting steps, it may begin issuing commands to the device controller 206. The first such command, represented by step 212, instructs the device controller 206 to open the settings application on the target device. This action may be the first step in navigating to the location where the IMEI information is stored. The device controller 206 may execute this command using various techniques, such as simulating user input or utilizing system-level APIs to interact with the device's operating system. After executing the command, the device controller 206 may capture the new state of the user interface and return this information to the LLM system 204, as shown by step 214. This feedback mechanism may allow the LLM system 204 to verify that the previous action was successful and to determine the next appropriate step based on the current state of the device's interface. The UI layout information returned by the device controller 206 may be in various formats, such as a structured text representation of the UI elements, a compressed image of the screen, and/or a hierarchical description of the UI components.

The LLM system 204 may then perform a verification step, represented by step 216, where it confirms that the layout matches what was expected after opening the settings application. This verification process may help ensure that the automation is progressing as intended and may allow the system to adapt to any unexpected changes and/or variations in the device's interface. The LLM system 204 may employ various techniques to perform this verification, such as comparing the received UI layout against a predicted or expected layout, identifying key UI elements that should be present, and/or analyzing the overall structure of the interface. In some examples, the LLM system 204 may use machine learning algorithms to improve its ability to verify and interpret UI layouts over time, potentially adapting to different device models, operating system versions, and/or application updates.

Following the successful verification, the LLM system 204 may issue the next command to the device controller 206, instructing it to navigate to the “About Phone” section, as shown by step 218. This step may bring the device closer to the location where the IMEI information is typically stored. The device controller 206 may execute this command using similar techniques as before, potentially simulating user input such as taps, swipes, and/or scrolls to navigate through the interface. Again, the device controller 206 may execute this command and return the updated UI layout to the LLM system 204, as indicated by step 220. This continuous feedback loop may allow the LLM system 204 to maintain an accurate understanding of the device's state throughout the process. The LLM system 204 may use this information to adjust its strategy if needed, potentially handling unexpected pop-ups, error messages, and/or alternative menu structures that may be encountered during the navigation process. Notably, the term “step” may be used generally in this disclosure in a colloquial sense, as a synonym for operation, without necessarily invoking or suggesting a presumption toward means-plus-function claiming.

In some examples, the user 202 may represent a diverse range of entities interacting with the natural language-driven device automation system. The user 202 may be a human individual directly inputting commands through various interfaces, such as voice recognition systems, text-based chat interfaces, and/or graphical user interfaces. In other scenarios, the user 202 may be an automated agent, such as a virtual assistant or another large language model, acting on behalf of a human user and/or an organization. The user 202 may also be a software application or service that generates natural language queries based on predefined rules, schedules, and/or events. In some implementations, the user 202 may be an enterprise-level entity, representing a collective group of individuals or systems within an organization, where the natural language inputs may be generated based on organizational policies, workflows, and/or business logic. The user 202 may interact with the system through various channels, including but not limited to mobile applications, web interfaces, command-line tools, and/or integration with other software systems. In some cases, the user 202 may be a message board account or a user account within a larger ecosystem, where the natural language inputs may be part of a broader conversation or thread. The user 202 may also be a residential or consumer entity, interacting with home automation systems or personal devices. Additionally, the user 202 may represent an IoT (Internet of Things) device or network of devices that generate natural language queries based on sensor data and/or predefined triggers. The system may be designed to handle multiple concurrent users, each with potentially different levels of access, permissions, and/or customization options. The user 202 may also be part of a hierarchical structure, where certain users may have the ability to define and/or modify the behavior of the system for other users within their organization or group.

In some examples, the LLM system 204 may encompass a wide range of advanced natural language processing technologies and techniques. The LLM system 204 may utilize various types of large language models, including but not limited to transformer-based models, recurrent neural networks, and/or future architectures that may emerge in the field of natural language processing when having the same functionality as LLMs (and beyond). The system may employ multiple specialized LLMs, each fine-tuned for specific tasks such as intent recognition, task decomposition, and/or dialogue management. In some implementations, the LLM system 204 may incorporate ensemble techniques, combining outputs from multiple models to improve accuracy and/or robustness. The LLM system 204 may also include adaptive components that allow it to learn and improve its performance over time based on user interactions and/or feedback. This may involve techniques such as online learning, transfer learning, and/or reinforcement learning. The system may utilize various pre-processing and post-processing techniques to enhance the quality of inputs and outputs, such as entity recognition, coreference resolution, and/or context management across multiple turns of conversation. In some scenarios, the LLM system 204 may incorporate multimodal capabilities, allowing it to process and generate not only text but also other forms of data such as images, audio, and/or structured data. The system may also include mechanisms for explaining its decision-making process, providing transparency and/or auditability. Additionally, the LLM system 204 may be designed with privacy and security considerations in mind, potentially incorporating techniques such as federated learning and/or differential privacy to protect user data. The system may also include fallback mechanisms and graceful degradation strategies for handling cases where the primary LLM may not be available or may produce unreliable results.

In some examples, the device controller 206 may represent a versatile and adaptable component capable of interfacing with a wide range of devices and systems. The device controller 206 may utilize various techniques to interact with target devices, including but not limited to simulating user input events (e.g., touch events, key presses, mouse movements), making API calls to device operating systems and/or applications, and/or utilizing system-level hooks or accessibility features. The device controller 206 may be designed to work across multiple platforms and operating systems, potentially employing a plugin architecture that allows for easy extension to new device types and/or protocols. In some implementations, the device controller 206 may include capabilities for remote device management, allowing it to control devices over networks using protocols such as SSH, RDP, and/or custom remote control protocols. The system may incorporate techniques for device discovery and automatic configuration, potentially utilizing technologies such as UPnP, Bonjour, and/or Bluetooth Low Energy for local device detection. The device controller 206 may also include mechanisms for handling device-specific quirks and variations, potentially maintaining a database of device profiles and/or employing machine learning techniques to adapt to new devices. In some scenarios, the device controller 206 may be capable of parallel execution, controlling multiple devices simultaneously and/or performing multiple actions on a single device concurrently. The system may also include robust error handling and recovery mechanisms, allowing it to gracefully handle scenarios such as device disconnections, unresponsive applications, and/or unexpected system states. Additionally, the device controller 206 may incorporate telemetry and logging capabilities, providing detailed information about its actions for debugging, auditing, and/or performance optimization purposes. The system may also include mechanisms for prioritizing and scheduling actions across multiple devices and/or users, potentially incorporating concepts like fair queuing and/or priority-based execution.

In some examples, the system may employ a diverse array of input techniques to facilitate user interaction and task execution. These input methods may range from traditional physical interactions to more advanced programmatic interfaces. Users may interact with the system through various physical input mechanisms, such as clicking or tapping on touchscreens, pressing buttons on keyboards or remote controls, scrolling using mouse wheels or touchpad gestures, and/or swiping on touch-sensitive surfaces. Voice commands may also be utilized, potentially employing speech-to-text conversion technologies to translate spoken instructions into actionable inputs. Gesture-based inputs may be incorporated, allowing users to control devices through hand movements captured by cameras or motion sensors. In some scenarios, eye-tracking technologies may be employed to interpret user gaze as input, particularly useful for users with limited mobility. The system may also support more direct input methods, such as text-based commands entered through command-line interfaces or chat-like interfaces. For programmatic interactions, APIs may be provided that allow other software systems or scripts to feed inputs directly into the automation system. These APIs may support various protocols and data formats, potentially including REST, GraphQL, and/or WebSocket interfaces. In some implementations, the system may accept structured data inputs, such as JSON or XML, allowing for more complex and precise command specifications. The input system may also be designed to handle batch processing of commands, allowing for the automation of multiple tasks through a single input operation. Additionally, the system may support context-aware inputs, where the interpretation of a command may depend on the current state of the device or previous interactions. The input processing component may also incorporate error correction and input prediction features, potentially improving the user experience by suggesting or automatically correcting common input errors.

In some examples, the system may utilize various techniques to capture and analyze the user interface (UI) layout without relying necessarily on image capture. One such technique may involve accessing the device's accessibility API, which may provide a hierarchical representation of UI elements, including their properties, relationships, and current states. This technique may allow the system to obtain detailed information about the UI structure without the need for visual processing. Another technique may involve intercepting and analyzing the UI rendering process at the framework or operating system level, potentially providing access to the underlying data structures that define the UI layout. In some scenarios, the system may utilize instrumentation or hooking techniques to intercept UI-related function calls or events, allowing it to build a model of the UI structure in real-time. For web-based interfaces, the system may employ techniques such as DOM (Document Object Model) parsing and/or JavaScript-based UI analysis to extract structural information. In cases where direct access to the UI framework is not possible, the system may utilize reflection or introspection techniques to examine the internal state of UI components. Some implementations may employ a hybrid technique, combining multiple methods to build a comprehensive understanding of the UI layout. The system may also maintain a cache or history of UI layouts, potentially allowing it to predict or infer the current layout based on previous states and known transition patterns. Additionally, the UI capture process may incorporate machine learning techniques to improve its accuracy and efficiency over time, potentially adapting to new UI patterns and device-specific quirks.

In some examples, the system may employ various UI automation frameworks to interact with and extract information from device interfaces. One such framework may be Appium, which may provide cross-platform automation capabilities for mobile and desktop applications. Appium may utilize a client-server architecture and may support multiple programming languages for test scripting. Alternative frameworks that may be used in place of or in conjunction with Appium may include Selenium WebDriver for web-based interfaces, XCUITest for iOS-specific automation, or Espresso for Android-specific automation. In some implementations, the system may employ a custom-built UI interaction layer that leverages low-level system APIs to capture and manipulate UI elements. This custom solution may be tailored to the specific goals of the natural language-driven automation system, potentially offering enhanced performance or compatibility with a wider range of devices. The choice of UI automation framework may depend on factors such as the target devices, the level of access required, and the complexity of the interactions needed. Some implementations may use a combination of frameworks, selecting the most appropriate tool based on the current device and task context. The UI automation component may also incorporate machine learning techniques to improve its ability to interpret and interact with diverse and evolving user interfaces over time.

In some examples, when image capture and processing are preferred, the system may employ a range of advanced techniques to efficiently analyze and interpret UI screenshots. The image capture process may utilize various optimization techniques to minimize resource usage, such as capturing only regions of interest and/or employing adaptive frame rates based on UI activity. Once captured, the images may undergo preprocessing steps such as noise reduction, contrast enhancement, and/or color normalization to improve the quality of subsequent analysis. Compression techniques may be applied to reduce storage and transmission requirements, potentially utilizing lossy or lossless algorithms depending on the specific use case and quality preferences. These may include standard image compression formats like JPEG or PNG, as well as more specialized algorithms designed for UI screenshots. Object detection techniques may be employed to identify and localize specific UI elements within the captured images. This may involve the use of convolutional neural networks (CNNs) or other deep learning architectures trained on large datasets of UI components. The system may also incorporate optical character recognition (OCR) techniques to extract text information from the images, potentially employing specialized models optimized for UI fonts and layouts. In some implementations, the image processing pipeline may include semantic segmentation to classify different regions of the UI according to their function or content type. The system may also employ template matching or feature detection algorithms to identify specific icons, buttons, or other UI patterns. To handle variations in device resolutions and screen sizes, the image processing component may incorporate scaling and normalization techniques. Additionally, the system may employ techniques for detecting and compensating for visual artifacts such as screen glare or color distortion. The image processing pipeline may also include mechanisms for temporal analysis, comparing sequences of screenshots to detect changes and animations in the UI. In some scenarios, the system may utilize depth information from devices with 3D-sensing capabilities to enhance its understanding of the UI layout and user interactions.

In some examples, the process of breaking down a goal into subgoals may involve a multi-faceted technique that leverages various components of the system. One method may involve feeding the goal directly to a large language model (LLM), which may analyze the natural language input and generate a structured list of subgoals. This LLM may be a general-purpose model fine-tuned for task decomposition, and/or it may be a specialized LLM specifically trained on a large dataset of complex tasks and their corresponding subtasks. In some scenarios, the system may employ an ensemble of LLMs, each specializing in different domains or task types, and combine their outputs to generate a more comprehensive and accurate breakdown. The goal decomposition process may also incorporate non-LLM logic, such as rule-based systems and/or decision trees, which may be particularly useful for handling domain-specific tasks or enforcing certain constraints. These non-LLM components may work alone or in tandem with the LLM, potentially serving as a pre-processing step to structure the input and/or a post-processing step to refine the LLM's output. In some implementations, the system may utilize an add-on or plugin architecture, allowing for the integration of specialized modules designed to handle specific types of goals and/or subgoals. This modular technique may enable the system to be easily extended and customized for various use cases and domains. The goal breakdown process may also incorporate feedback loops, where the initial decomposition is iteratively refined based on the system's attempts to execute the subgoals. This may involve techniques such as backtracking and/or dynamic replanning when certain subgoals prove to be unachievable or inefficient. Additionally, the system may maintain a knowledge base of previously decomposed goals and their successful subgoal breakdowns, potentially allowing it to learn and improve its decomposition strategies over time through techniques such as case-based reasoning and/or reinforcement learning.

In some examples, the natural language-driven device automation system may be capable of handling a wide range of tasks, each with its own set of complexities and potential limitations. Tasks that may be realistically achievable may include device configuration changes, such as adjusting display settings, managing network connections, and/or updating system preferences. The system may excel at information retrieval tasks, such as finding specific details within applications, searching for files or emails, and/or gathering system information like device specifications and/or software versions. User interface navigation tasks may also be well-suited for automation, including opening specific applications, navigating through menus, and/or accessing particular features within complex software interfaces. The system may be adept at performing data entry tasks, such as filling out forms, inputting contact information, and/or updating calendar entries. Communication-related tasks may also be achievable, including sending emails, composing text messages, and/or making voice calls. In the realm of media management, the system may be capable of tasks such as organizing photo libraries, creating playlists, and/or adjusting playback settings on various media applications.

In some examples, the natural language-driven device automation system may produce a wide range of concrete, real-world outcomes that extend beyond mere information processing and/or mental steps. The system may modify system-level configurations, potentially altering the behavior and/or performance characteristics of the device. These modifications may include adjusting power management settings to extend battery life, optimizing memory allocation to improve overall system responsiveness, and/or fine-tuning processor clock speeds to balance performance and energy consumption. The system may interact with hardware components, potentially triggering actions such as activating haptic feedback mechanisms, controlling LED indicators, and/or managing peripheral devices. In some scenarios, the system may generate non-textual outputs, such as synthesizing audio responses, creating visual notifications, and/or initiating tactile alerts through vibration motors. The automation capabilities may extend to network-related functions, potentially including configuring firewall rules, managing virtual private network (VPN) connections, and/or optimizing quality of service (QoS) settings for different types of network traffic. The system may interact with low-level system resources, potentially modifying kernel parameters, adjusting I/O scheduling algorithms, and/or managing system services to improve overall device stability and performance. In the realm of storage management, the system may perform actions such as initiating disk defragmentation, managing file system journaling settings, and/or optimizing solid-state drive (SSD) wear-leveling algorithms. The automation may also extend to security-related functions, potentially including updating encryption protocols, managing biometric authentication settings, and/or configuring system-wide access control policies. In some implementations, the system may interact with device drivers, potentially fine-tuning hardware-specific settings to optimize performance and/or compatibility across a wide range of peripherals and components.

In some examples, the natural language-driven device automation system may extend its influence beyond the digital realm to effect changes in the physical world through various interconnected devices and services. The system may issue commands to robotic systems, potentially instructing robotic arms to perform manipulation tasks, guiding autonomous robots to navigate environments, and/or directing mobile robots to move to specific locations. In the realm of unmanned aerial vehicles, the system may generate instructions for drones, potentially coordinating flight operations, facilitating aerial maneuvers, and/or managing navigation in various environments. The automation capabilities may interface with e-commerce platforms, potentially initiating transactions, selecting options, and/or managing account settings based on user inputs. In the domain of digital manufacturing, the system may interact with additive manufacturing devices, potentially adjusting operational parameters, selecting production options, and/or optimizing fabrication processes. The system's reach may extend to smart home ecosystems, potentially adjusting environmental controls, managing power systems, and/or controlling water distribution based on input criteria. In the realm of home entertainment, the system may coordinate audio-visual systems, potentially synchronizing playback across devices, adjusting output settings, and/or creating content selections based on specified criteria. The automation may also interface with smart appliances, potentially modifying operational modes, adjusting internal settings, and/or initiating programmed routines. In some scenarios, the system may interact with wearable devices, potentially adjusting device parameters, customizing notification protocols, and/or initiating communication functions if certain conditions are met. The system's capabilities may extend to vehicle systems, potentially activating vehicle functions, optimizing energy management, and/or adjusting mechanical settings based on received inputs. Through these diverse interactions, the system may demonstrate its ability to translate natural language inputs into concrete, real-world actions across a wide range of devices and platforms, showing its potential for broad applicability and impact in various domains of automation and control.

In some examples, the natural language-driven device automation system may operate through various mechanisms, depending on the specific implementation and/or the target device ecosystem. One potential technique may involve running the system as a background process on the user's device, continuously listening for voice commands and/or monitoring designated input channels for text-based instructions. This background process may be implemented as a system service, potentially leveraging native operating system features for efficient resource management and/or system-wide accessibility. In some scenarios, the functionality of the system may be implemented in Python, taking advantage of its rich ecosystem of libraries for natural language processing, machine learning, and/or device interaction. The Python codebase may be compiled into a native executable for improved performance and/or packaged as a standalone application. Alternatively, the system may be integrated directly into the operating system as a native feature, potentially offering deeper integration with system-level APIs and/or improved performance. This technique may involve close collaboration with operating system vendors and/or may be implemented by the OS developers themselves. Another potential implementation may involve a third-party application with elevated privileges, allowing it to interact with and/or control other applications on the device. This technique may require careful consideration of security implications and/or may involve a rigorous vetting process by app store operators. In some implementations, the system may operate as a distributed application, with certain components running locally on the user's device and others operating in the cloud. This hybrid technique may allow for the offloading of computationally intensive tasks, such as large language model inference, to more powerful remote servers while maintaining responsiveness for local device interactions. The system may also be implemented as a browser extension and/or web application, potentially offering cross-platform compatibility at the expense of some system-level integration capabilities. In enterprise environments, the system may be deployed as a managed service, potentially integrated with existing IT infrastructure and/or subject to centralized policy controls.

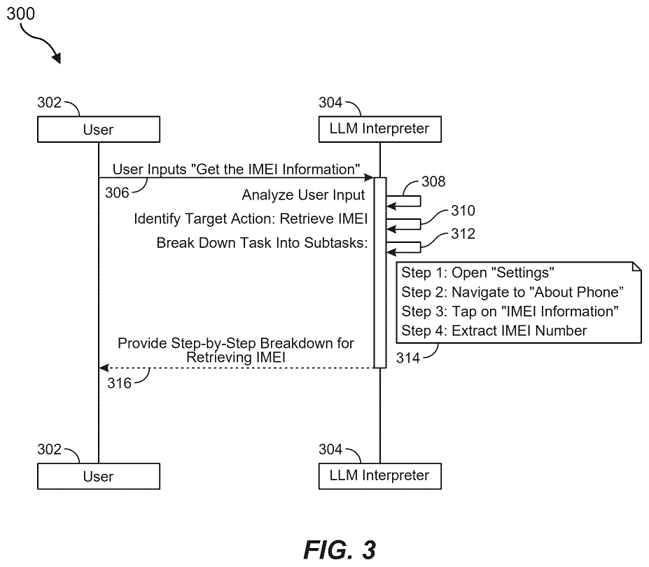

FIG. 3 illustrates an example sequence diagram depicting the interaction between a user 302 and an LLM interpreter 304 during the process of interpreting a natural language input and breaking it down into actionable steps. This figure provides a detailed view of how the LLM interpreter 304 may analyze and process the user's request, demonstrating the internal steps involved in transforming a high-level command into a sequence of specific actions. The sequence begins with the user 302 initiating the process by providing a natural language input, as shown by step 306. In this example, the user's request is to “Get the IMEI information” from a device. Upon receiving this input, the LLM interpreter 304 may begin a series of internal processing steps to understand and decompose the user's request. The LLM interpreter 304 may employ various techniques to handle different phrasings and variations of the same request, potentially recognizing synonyms and/or context-specific terminology. In some scenarios, the interpreter may also consider user preferences and/or past interactions to better understand the intent behind the request.

The first step in this process, represented by step 308, involves the LLM interpreter 304 analyzing the user input. This analysis may involve various natural language processing techniques, such as tokenization, part-of-speech tagging, and/or semantic parsing. The LLM interpreter 304 may employ contextual understanding to disambiguate terms and infer the user's intent, even if the request contains colloquialisms and/or domain-specific jargon. Additionally, the interpreter may utilize techniques such as named entity recognition to identify specific device components and/or settings mentioned in the request. In some implementations, the LLM interpreter 304 may also perform sentiment analysis to gauge the user's emotional state and/or urgency, potentially adjusting its response strategy accordingly. The analysis process may also involve techniques for handling multi-lingual inputs and/or code-switching, allowing the system to cater to a diverse user base.

Following the initial analysis, the LLM interpreter 304 may proceed to identify the target action, as shown by step 310. In this case, the interpreter recognizes that the goal is to retrieve the IMEI (International Mobile Equipment Identity) information. This step may involve mapping the natural language request to a predefined set of actions and/or goals that the system is capable of performing. The identification process may utilize techniques such as intent classification and/or sequence-to-sequence models to determine the most appropriate action based on the analyzed input. In some scenarios, the LLM interpreter 304 may consider multiple potential interpretations of the user's request and rank them based on confidence scores. The system may also take into account device-specific capabilities and/or user permissions when determining the feasibility of the identified target action. If the target action is ambiguous and/or requires additional clarification, the LLM interpreter 304 may generate follow-up questions to refine its understanding of the user's intent.

FIG. 2 and FIG. 3 present complementary views of the natural language-driven device automation process, each focusing on different aspects of the system's operation. While FIG. 2 provides an example overview of the entire process flow from user input to task execution, FIG. 3 offers a more detailed examination of the initial interpretation phase. FIG. 2 illustrates the interaction between the user 202, LLM system 204, and device controller 206, showing the high-level steps involved in processing a request and executing actions on a device. In contrast, FIG. 3 zooms in on the internal workings of the LLM interpreter 304, revealing the nuanced steps it may take to analyze and decompose a user's natural language input. This detailed view in FIG. 3 may help illuminate the complexity involved in bridging the gap between human language and machine-executable instructions. Where FIG. 2 demonstrates the back-and-forth communication between system components, FIG. 3 emphasizes the cognitive-like processes occurring within the LLM interpreter itself. The breakdown of subtasks shown in FIG. 3's explanatory box 314 may correspond to the series of commands sent from the LLM system to the device controller in FIG. 2. By presenting these two perspectives, the figures may collectively offer a more comprehensive understanding of how the system may interpret, plan, and execute user requests, highlighting both the overall workflow and the intricate language processing that underpins the automation process.

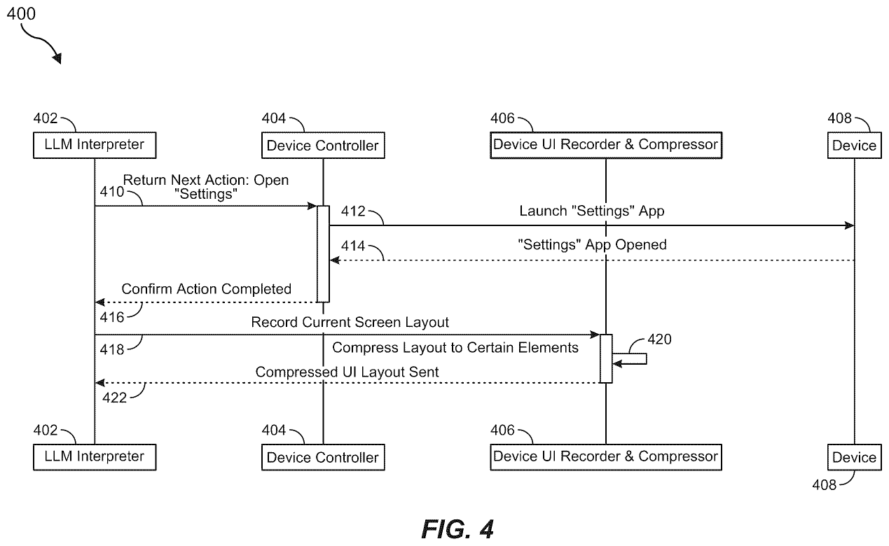

FIG. 4 illustrates an example sequence diagram depicting the interactions between an LLM interpreter 402, a device controller 404, a device UI recorder and compressor 406, and a device 408 during the execution of a specific action in the natural language-driven device automation process. This figure provides a detailed view of how the system may execute a single step of the overall task, demonstrating the flow of information and actions between different components of the system. The sequence begins with the LLM interpreter 402 initiating the process by sending the next action to be performed to the device controller 404, as shown by step 410. In this example, the action is to open the “Settings” application on the device 408. This step may follow the initial interpretation and task breakdown process illustrated in previous figures. The LLM interpreter 402 may have determined this action based on its analysis of the user's request and its understanding of the steps performed to achieve the desired goal. In some scenarios, the LLM interpreter 402 may consider multiple potential actions and select the most appropriate one based on factors such as the current device state, user preferences, and/or the specific context of the task being performed.

Upon receiving the instruction, the device controller 404 may proceed to execute the action on the device 408. This is represented by step 412, which shows the device controller 404 instructing the device 408 to launch the “Settings” application. The device controller 404 may employ various techniques to interact with the device 408, potentially including simulating user input, making API calls, and/or utilizing system-level commands. The specific method used may depend on the type of device, its operating system, and/or the particular application being accessed. In some implementations, the device controller 404 may have multiple interaction strategies available and may select the most appropriate one based on factors such as reliability, speed, and/or resource efficiency. The device controller 404 may also implement error handling mechanisms to address potential issues that may arise during the execution of the action, such as unexpected system states and/or temporary device unresponsiveness.

After the action is executed, the device 408 may respond with a confirmation that the “Settings” application has been opened, as indicated by step 414. This feedback may be helpful for the system to verify that the requested action has been performed successfully. The device controller 404 may then relay this confirmation back to the LLM interpreter 402 through step 416, potentially including any relevant details and/or error information. This feedback loop may allow the LLM interpreter 402 to maintain an up-to-date understanding of the task's progress and the device's current state.

Following the action confirmation, the LLM interpreter 402 may instruct the device UI recorder and compressor 406 to capture the current screen layout, as shown by step 418. This step may be helpful for the system to understand the new state of the device's user interface after the action has been performed. Once the UI layout has been captured, the device UI recorder and compressor 406 may proceed to compress the layout information, as indicated by step 420. This compression process may involve reducing the captured UI data to certain elements or to its essential elements for a respective “essential” threshold or heuristic, potentially discarding unnecessary details while retaining the key information used for further analysis. The compression technique may utilize various algorithms such as lossless compression for text-based UI descriptions, lossy compression for visual elements, and/or semantic compression that retains only the most relevant UI components based on the current task context. In some scenarios, the compression algorithm may adapt its parameters based on factors such as the complexity of the UI, the available system resources, and/or the specific requirements of the subsequent analysis steps. The compressor may also employ machine learning techniques to identify patterns in UI layouts, potentially allowing for more efficient compression of commonly encountered interface structures. Finally, the compressed UI layout may be sent back to the LLM interpreter 402, as shown by step 422. This compressed representation of the device's current UI state may provide the LLM interpreter 402 with the information it needs to determine the next appropriate action in the task sequence. The LLM interpreter 402 may analyze this compressed layout to verify that the previous action was successful and to identify the relevant UI elements for the next step in the process.

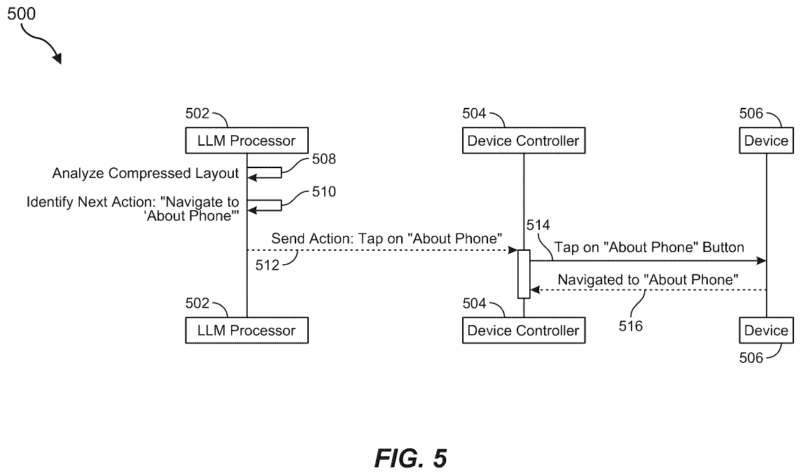

FIG. 5 illustrates an example sequence diagram depicting the interactions between an LLM processor 502, a device controller 504, and a device 506 during the execution of a specific action in the natural language-driven device automation process. This figure provides a detailed view of how the system may process the compressed UI layout and determine the next action to be performed. The sequence begins with the LLM processor 502 analyzing the compressed layout, as shown by step 508. This step may involve the LLM processor 502 interpreting the compressed representation of the device's user interface to understand the current state of the device and identify relevant UI elements. Following the analysis, the LLM processor 502 identifies the next action to be performed, as indicated by step 510. In this example, the next action is to navigate to the “About Phone” section. This decision may be based on the LLM processor's understanding of the overall task goal and its interpretation of the current UI state. Once the next action is determined, the LLM processor 502 sends the action to the device controller 504, as shown by step 512. The specific instruction in this case is to tap on the “About Phone” button or menu item. Upon receiving the instruction, the device controller 504 executes the action on the device 506. This is represented by step 514, which shows the device controller 504 instructing the device 506 to tap on the “About Phone” button. The device controller 504 may use various methods to simulate this tap action, depending on the device's interface and capabilities. Finally, the device 506 responds with a confirmation that it has successfully navigated to the “About Phone” section, as indicated by step 516. This feedback is sent to the device controller 504, completing the execution of the current action step.

FIG. 5 builds upon the processes illustrated in previous figures, particularly FIG. 4, by demonstrating the next phase in the automation sequence. While FIG. 4 focused on the initial action of opening the Settings application and capturing the UI layout, FIG. 5 shows how the system processes this captured information and proceeds with the subsequent step. This figure highlights the iterative nature of the automation process, where each action is followed by an analysis of the resulting UI state, leading to the determination and execution of the next appropriate action. The LLM processor 502 in FIG. 5 may correspond to the LLM interpreter 402 from FIG. 4, showing its role in both interpreting the UI state and deciding on actions. The compressed layout analysis shown in FIG. 5 directly utilizes the output of the UI recording and compression process depicted in FIG. 4, illustrating the continuity of the system's operations. Furthermore, FIG. 5 emphasizes the system's ability to navigate through multiple levels of a device's interface, progressing from the main Settings screen to a more specific “About Phone” section, thus demonstrating how complex, multi-step tasks may be broken down and executed sequentially.

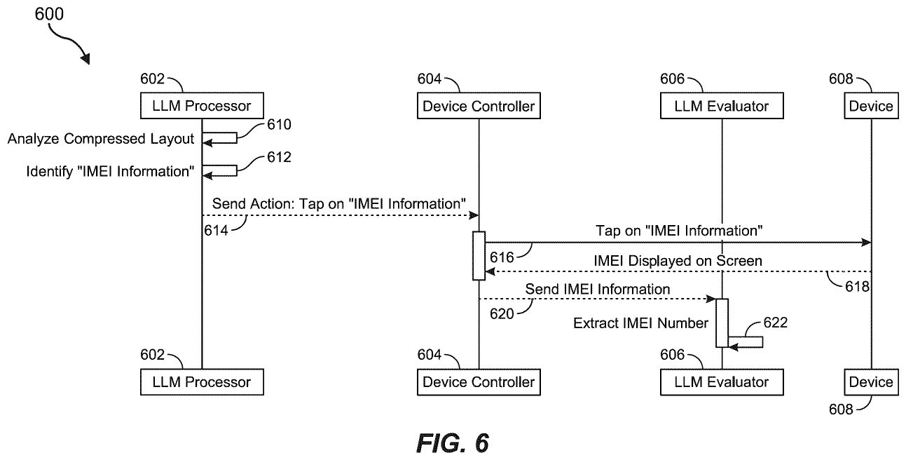

FIG. 6 illustrates an example sequence diagram depicting the interactions between an LLM processor 602, a device controller 604, an LLM evaluator 606, and a device 608 during the final stages of retrieving the IMEI information in the natural language-driven device automation process. This figure provides a detailed view of how the system may locate and extract the specific information requested by the user. The sequence begins with the LLM processor 602 analyzing the compressed layout, as shown by step 610. This step may involve the LLM processor 602 interpreting the compressed representation of the device's user interface to understand the current state of the device and identify relevant UI elements. The LLM processor 602 may employ various techniques to parse the compressed layout data, potentially including pattern matching algorithms, semantic analysis, and/or machine learning models trained on UI structures. Following the analysis, the LLM processor 602 identifies the “IMEI information” element in the UI, as indicated by step 612. This identification may be based on the LLM processor's understanding of the overall task goal and its interpretation of the current UI state. The processor may use techniques such as natural language processing to match the concept of “IMEI information” with various possible UI labels or descriptors that might represent this information in the device interface.

Once the IMEI information element is identified, the LLM processor 602 sends an action to the device controller 604, as shown by step 614. The specific instruction in this case is to tap on the “IMEI information” button or menu item. The LLM processor 602 may generate this instruction in a format that is compatible with the device controller's input requirements, which may vary depending on the specific implementation of the system. Upon receiving the instruction, the device controller 604 executes the action on the device 608. This is represented by step 616, which shows the device controller 604 instructing the device 608 to tap on the “IMEI information” element. The device controller 604 may translate the high-level “tap” instruction into specific commands or API calls that are appropriate for the particular device 608 being controlled. This translation process may involve consideration of the device's operating system, any accessibility features that may be in use, and/or the specific UI framework employed by the device.

The device 608 responds by displaying the IMEI on the screen, as indicated by step 618. This feedback is sent to the device controller 604, confirming that the requested information is now visible. The device controller 604 then sends the IMEI information to the LLM evaluator 606, as shown by step 620. This transfer of information may involve capturing the relevant portion of the screen, extracting text from the UI, and/or accessing system-level APIs to retrieve the IMEI data directly. The specific method used may depend on the capabilities of the device 608 and/or the permissions granted to the device controller 604. Finally, the LLM evaluator 606 extracts the IMEI number from the information provided, as depicted in step 622. This extraction process may involve parsing the displayed text to isolate the specific IMEI number from any surrounding information or formatting. The LLM evaluator 606 may employ techniques such as regular expression matching, format validation, and/or checksum verification to ensure that the extracted IMEI is accurate and complete. In some implementations, the LLM evaluator 606 may also perform additional processing on the extracted IMEI, such as formatting it according to user preferences or system requirements, before passing it back to other components of the system for final presentation to the user.

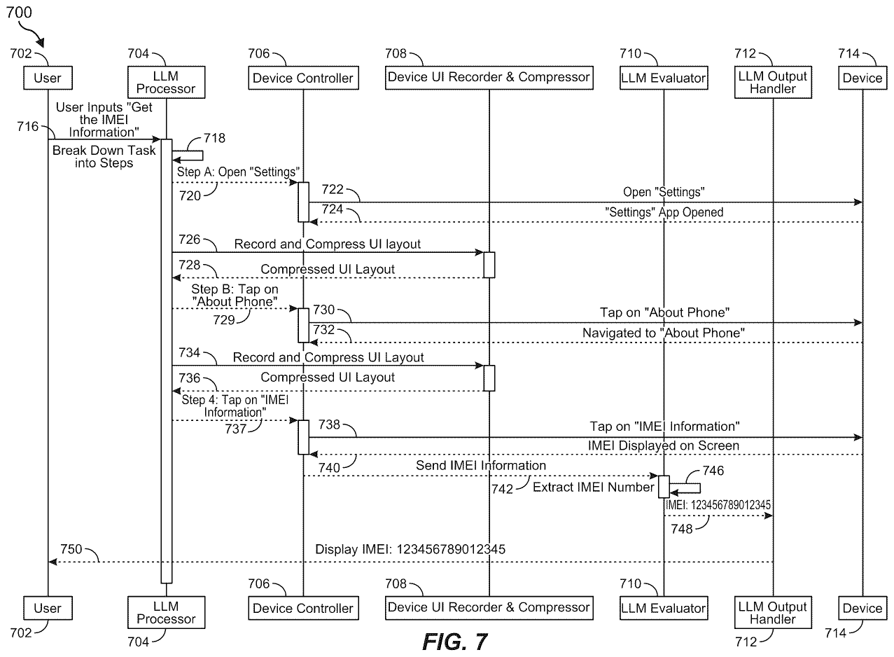

FIG. 7 illustrates an example sequence diagram depicting the interactions between a user 702, an LLM processor 704, a device controller 706, a device UI recorder and compressor 708, an LLM evaluator 710, an LLM output handler 712, and a device 714 during the entire process of retrieving IMEI information in the natural language-driven device automation system. The sequence begins with the user 702 providing input to the LLM processor 704, as shown in step 716. The input states “Get the IMEI information.” Upon receiving this input, the LLM processor 704 breaks down the task into steps, as indicated in step 718. The LLM processor 704 then instructs the device controller 706 to perform Step A, which is to open the “Settings” app, as shown in step 720. The device controller 706 executes this instruction on the device 714, as depicted in step 722. The device 714 confirms that the “Settings” app has been opened in step 724. Following this, the LLM processor 704 instructs the device UI recorder and compressor 708 to record and compress the UI layout, as shown in step 726. This step may involve capturing the current state of the device's user interface and reducing it to a more compact representation for efficient processing.

Next, the LLM processor 704 instructs the device controller 706 to perform Step B, which is to tap on “About Phone,” as indicated in step 728. The device controller 706 executes this action on the device 714 in step 730, and the device 714 confirms navigation to “About Phone” in step 732. Again, the LLM processor 704 instructs the device UI recorder and compressor 708 to record and compress the UI layout in step 734. This repeated recording and compression of the UI layout may allow the system to maintain an up-to-date understanding of the device's interface as it navigates through different screens. The LLM processor 704 then instructs the device controller 706 to tap on “IMEI Information” in step 736. The device controller 706 executes this action on the device 714 in step 738, and the device 714 confirms that the IMEI is displayed on the screen in step 740. This step may involve the device 714 accessing the IMEI information stored in its memory and rendering it on the display.

The device controller 706 sends the IMEI information to the LLM evaluator 710 in step 742. The LLM evaluator 710 extracts the IMEI number in step 746 and passes it to the LLM output handler 712 in step 748. The extraction process may involve parsing the information received from the device controller 706 to isolate the specific IMEI number from any surrounding text or formatting. Finally, the LLM output handler 712 displays the IMEI number (123456789012345) to the user 702 in step 750, completing the task. This final step may involve formatting the IMEI number for presentation and transmitting it through an appropriate user interface, which may be a text display, voice output, and/or any other suitable medium for conveying the information to the user 702.

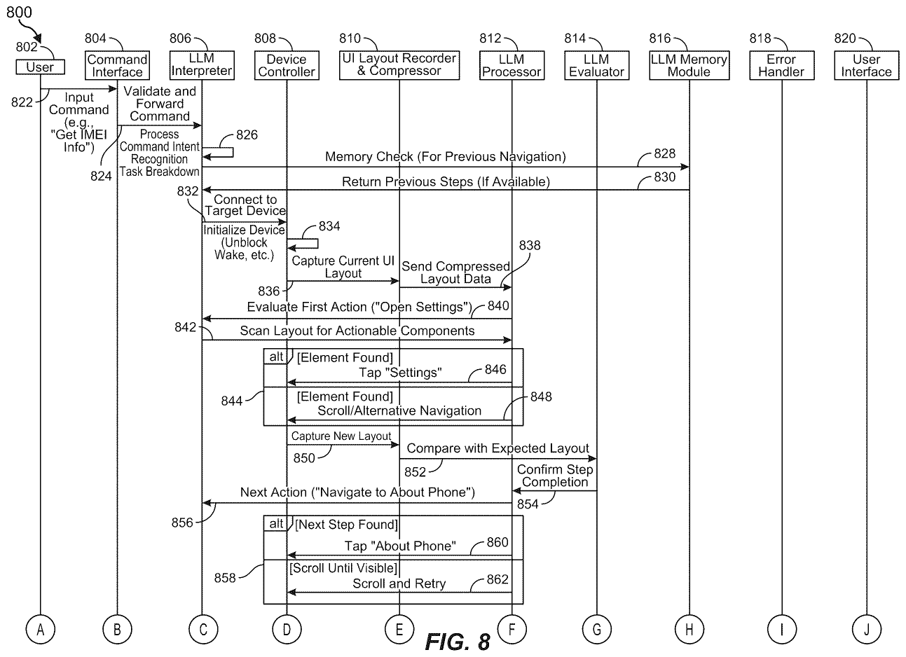

FIG. 8 illustrates an example sequence diagram depicting the interactions between various components of the natural language-driven device automation system. The diagram shows the flow of information and actions between a user 802, a command interface 804, an LLM interpreter 806, a device controller 808, a UI layout recorder and compressor 810, an LLM processor 812, an LLM evaluator 814, an LLM memory module 816, an error handler 818, and a user interface 820. This comprehensive diagram may provide insights into the interplay of different system components and the step-by-step process of executing a natural language command. The inclusion of multiple specialized modules may highlight the system's modular design, potentially allowing for flexibility and extensibility in handling various types of commands and device interactions.

The sequence begins with the user 802 inputting a command, such as “get IMEI info,” to the command interface 804, as shown in step 822. This initial step may represent the entry point for user interaction, where natural language inputs are received and prepared for processing. The command interface 804 then validates and forwards the command to the LLM interpreter 806 in step 824. This validation step may serve as a preliminary filter, potentially catching malformed inputs or unauthorized commands before they reach the more computationally intensive interpretation stage. The LLM interpreter 806 processes the command, performing intent recognition and task breakdown, as indicated in step 826. This step may involve sophisticated natural language processing techniques to extract the user's intent and decompose it into actionable tasks. The interpreter may employ various algorithms, such as semantic parsing or intent classification, to accurately understand the user's request in the context of device automation.

Following this, the LLM interpreter 806 performs a memory check for previous navigation in step 828, querying the LLM memory module 816. If available, the memory module returns previous steps in step 830. This memory lookup mechanism may enhance the system's efficiency by leveraging past interactions to inform current actions. It may allow the system to learn from previous executions, potentially optimizing frequently performed tasks or adapting to user-specific patterns of interaction. The LLM interpreter 806 then instructs the device controller 808 to connect to the target device in step 832. This connection step may involve various protocols depending on the type of device being controlled, potentially including wireless communication standards, USB connections, or network-based interactions.

The device controller 808 initializes the device, potentially unblocking or waking it, as shown in step 834. This initialization process may be helpful to ensure that the device is in a ready state for interaction, which may involve actions such as turning on the screen, unlocking the device, and/or launching necessary background services. It then captures the current UI layout, passing this information to the UI layout recorder and compressor 810 in step 836. The UI capture process may involve techniques such as screenshot analysis, accessibility API queries, and/or OCR (Optical Character Recognition) to build a comprehensive understanding of the device's current interface state. The compressed layout data is sent to the LLM processor 812 in step 838. This compression step may be helpful in reducing data transfer and storage requirements, potentially enabling faster processing and more efficient use of system resources.

The LLM processor 812 evaluates the first action, “open settings,” in step 840, and then scans the layout for actionable components in step 842. This evaluation process may involve analyzing the compressed UI layout to identify interactive elements that correspond to the desired action. The LLM processor 812 may employ various techniques such as pattern matching, semantic analysis, and/or machine learning models trained on UI element recognition to accurately identify the relevant components. The scanning process may be adaptive, potentially adjusting its search parameters based on the specific device model, operating system version, and/or application context.

The diagram shows two alternative paths at this point, represented by the ALT blocks 844 and 858. These alternative paths may illustrate the system's ability to handle different scenarios that may arise during the execution of a task, showcasing its adaptability and robustness. In the first alternative path (block 844), steps 846 and 848 are presented. Step 846 indicates that the element is found, and “settings” is tapped. This may represent the ideal scenario where the desired UI element is immediately visible and accessible. Step 848, on the other hand, shows that scroll or alternative navigation may be performed. This step may be helpful when the target element is not immediately visible, requiring additional navigation actions. The system may employ various scrolling techniques, such as simulating swipe gestures or using programmatic scrolling APIs, to navigate through the interface. Alternative navigation methods may include searching for related UI elements, using system-level shortcuts, and/or leveraging accessibility features to locate the desired component.

Following either of these actions, the device controller 808 captures a new layout in step 850. This repeated capture process may be helpful to maintain an up-to-date understanding of the UI state after each action, enabling the system to verify the results of its operations and plan subsequent steps accordingly. The newly captured layout is then compared with the expected layout by the LLM evaluator 814 in step 852. This comparison step may involve sophisticated image processing techniques, structural analysis of UI element hierarchies, and/or semantic comparison of textual content. The LLM evaluator 814 may use various metrics to determine the similarity between the actual and expected layouts, potentially accounting for minor variations or inconsistencies that may not affect the overall task progression.

The LLM evaluator 814 confirms step completion to the LLM processor 812 in step 854. This confirmation may serve as a checkpoint in the task execution process, potentially triggering the next phase of the operation or initiating error handling procedures if one or more discrepancies are detected. The LLM processor 812 then extracts the next action, “navigate to about phone,” and sends it to the LLM interpreter 806 in step 856. This extraction process may involve analyzing the overall task structure, considering the current progress, and/or determining the most appropriate next step based on the confirmed UI state.

The second alternative path, represented by block 858, includes steps 860 and 862. In step 860, the next step is found, and “about phone” is tapped. This may represent a scenario where the system successfully navigates to the next phase of the task without encountering obstacles. Step 862, however, indicates a situation where the system may need to scroll until the element is visible, and then retry the action. This step may be helpful in handling cases where the target element is not immediately accessible, thereby involving additional navigation actions. The system may employ various scrolling algorithms, potentially combining fixed-distance scrolling with intelligent content analysis to efficiently locate the desired element.

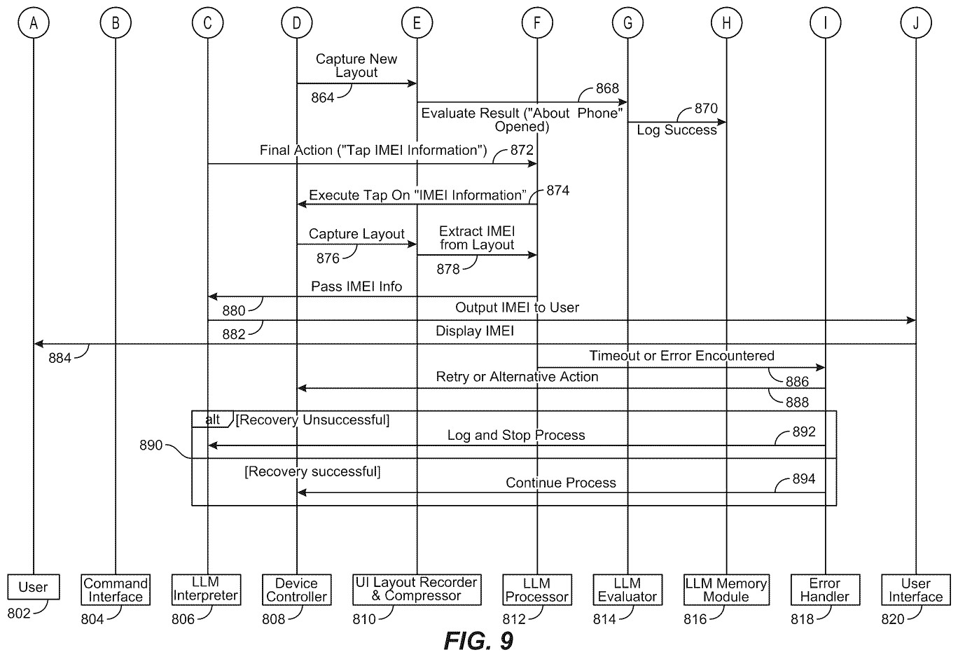

FIG. 9 illustrates an example continuation of the sequence diagram from FIG. 8, depicting further interactions between the components of the natural language-driven device automation system. This figure shows the progression of steps following the navigation to the “About Phone” section, as well as potential error handling scenarios. The sequence continues with step 864, where the device controller 808 captures a new layout and sends it to the UI layout recorder and compressor 810. This step may be helpful in verifying that the system has successfully navigated to the “About Phone” section and in preparing for the next action. The UI layout capture may involve various techniques to obtain a representation of the current screen state, which may be helpful for subsequent analysis and decision-making processes.

In step 868, the UI layout recorder and compressor 810 sends the captured and processed layout to the LLM evaluator 814, which evaluates the result to confirm that the “About Phone” section has been successfully accessed. This evaluation step may involve comparing the captured layout against expected patterns or templates for the “About Phone” interface. The LLM evaluator 814 may analyze various aspects of the layout, such as the presence of specific UI elements, the overall structure of the interface, and/or the textual content displayed on the screen. This evaluation process may be helpful in ensuring that the system is on the correct path to completing the user's request and in detecting any potential navigation errors or unexpected UI states.

Following a successful evaluation, the LLM evaluator 814 logs the success in the LLM memory module 816, as shown in step 870. This logging process may be helpful for improving future interactions by allowing the system to learn from successful navigation paths and optimize its decision-making in subsequent executions of similar tasks. The logged information may include details such as the sequence of actions taken, any alternative paths explored, and/or the time taken to complete each step. This accumulated knowledge may be helpful in refining the system's performance over time and in handling similar requests more efficiently in the future.

The LLM interpreter 806 then determines the final action, which is to access the “IMEI information,” and communicates this to the LLM processor 812 in step 872. This step may involve analyzing the overall task structure and recognizing that accessing the IMEI information is the ultimate goal of the user's original request. The LLM interpreter 806 may formulate a specific instruction to achieve this goal based on its understanding of the current UI state and the typical location of IMEI information within the device settings. In step 874, the device controller 808 executes the instruction to tap on the “IMEI information” element within the UI. This action may be performed through simulated touch events, accessibility API commands, and/or other interface interaction methods appropriate for the specific device and operating system.

Following this action, the device controller 808 captures another layout in step 876, sending it to the UI layout recorder and compressor 810. This additional capture may be helpful in verifying that the IMEI information is now displayed on the screen and in locating the specific area where the information is presented. The LLM processor 812 then extracts the IMEI from the layout in step 878. This extraction process may involve techniques such as text recognition, pattern matching, and/or semantic analysis to identify and isolate the IMEI number from surrounding UI elements and text. The system may also perform validation checks to ensure that the extracted information matches the expected format and structure of an IMEI number.

Once the IMEI is successfully extracted, the LLM processor 812 passes this information to the LLM interpreter 806 in step 880. The LLM interpreter 806 may perform additional processing or formatting on the IMEI information to prepare it for presentation to the user. The interpreter then outputs the processed IMEI information to the user interface 820 in step 882. Finally, the user interface 820 displays the IMEI to the user 802 in step 884, completing the primary goal of the interaction. This display step may involve formatting the IMEI for clear presentation and may include additional context or instructions for the user.

The diagram also illustrates potential error handling scenarios, which may be helpful in addressing unexpected situations or failures during the task execution. In step 886, the LLM processor 812 may detect a timeout or error condition. This detection may occur if the expected UI elements are not found within a specified time frame, if the extracted information does not match the expected format, and/or if any other unexpected conditions arise during the process. Upon detecting such an error, the LLM processor 812 may notify the error handler 818. The error handler 818 may then initiate retry or alternative action procedures, as shown in step 888. These procedures may involve attempting the failed action again, exploring alternative navigation paths, and/or adjusting the interaction strategy based on the specific error encountered.

The diagram includes an alternative (ALT) block 890, which shows two possible outcomes of the error handling process. This block may be helpful in illustrating the system's ability to adapt to different scenarios and its strategies for handling both successful and unsuccessful recovery attempts. In step 892, if the recovery is unsuccessful, the error handler 818 logs the failure and stops the process, communicating this outcome to the LLM interpreter 806. This logging of unsuccessful attempts may be helpful for future analysis and improvement of the system's error handling capabilities. Alternatively, in step 894, if the recovery is successful, the error handler 818 instructs the device controller 808 to continue the process, potentially returning to an earlier step in the sequence to reattempt the task with the newly gained information or adjusted strategy. This adaptive approach may be helpful in overcoming temporary obstacles or minor inconsistencies in the UI, potentially increasing the overall success rate of task completion.

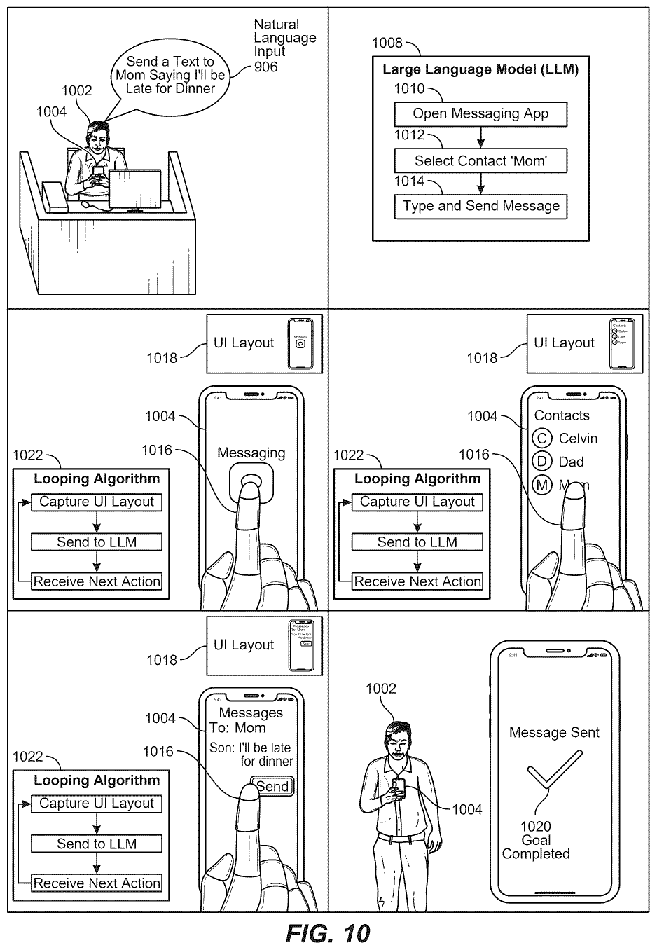

FIG. 10 illustrates an example sequence of panels depicting a natural language prompt execution for sending a text message. In the first panel, a User 1002 is shown sitting at a desk with a smartphone Device 1004 in hand. This representation may depict a typical user environment where natural language interactions with devices may occur. The user's posture and positioning may suggest a casual, everyday scenario where such interactions might be common. Above the user, a speech bubble labeled “Natural Language Input 1006” contains the text “Send a text to Mom saying I'll be late for dinner.” This speech bubble may represent the user's verbal command or typed input to the device, showing how natural language may be used to initiate complex tasks. The specific wording of the command may demonstrate the system's ability to interpret colloquial language and personal references, such as “Mom” instead of a formal contact name.

The second panel displays a simplified representation of the LLM processing the request. A large rectangle labeled “Large Language Model (LLM) 1008” contains three smaller rectangles representing the steps: “Step 1: Open messaging app 1010,” “Step 2: Select contact ‘Mom’ 1012,” and “Step 3: Type and send message 1014.” Arrows connect these steps in sequence. This visual representation may illustrate how the LLM breaks down the user's natural language input into discrete, actionable steps. The sequencing of these steps may demonstrate the LLM's understanding of the logical order of operations needed to complete the task. The simplification of complex actions into these three steps may showing the LLM's ability to abstract high-level user intentions into specific device operations. Each step may correspond to a distinct action that the device will need to perform, bridging the gap between the user's natural language request and the technical operations of the device.

Panel three illustrates the Device 1004 screen showing the messaging app opening. A stylized Hand 1016 is touching the messaging app icon. This representation may depict the system's ability to interact with the device's user interface, simulating human touch inputs. The hand's positioning on the app icon may indicate precise control over the device's touchscreen interface. In the top-right corner, a small rectangle labeled “UI Layout 1018” contains a simplified representation of the current screen layout. This UI Layout 1018 element may represent the system's real-time understanding of the device's interface, which may be crucial for navigation and interaction. The simplified nature of this layout representation may suggest a data-efficient method of capturing and processing UI information. The presence of this UI Layout 1018 in the corner of the panel may indicate that this information is continuously monitored and updated throughout the task execution process.

The fourth panel shows the Device 1004 screen with a list of contacts. Hand 1016 is selecting “Mom” from the list. This visualization may demonstrate the system's ability to navigate through different screens and menus within an application. The selection of “Mom” from the contact list may show the system's capability to match the user's natural language reference (“Mom”) with the corresponding entry in the device's contact list. This may involve natural language processing techniques to handle variations in contact names and nicknames. The UI Layout 1018 rectangle in the top-right corner is updated to reflect the current screen. This update may illustrate the dynamic nature of the UI layout capture process, adapting to each new screen as the task progresses. The consistent presence of this UI Layout 1018 across panels may emphasize its importance in guiding the system's actions throughout the task execution.

FIG. 10 illustrates an example sequence of panels depicting a natural language prompt execution for sending a text message. In the top-left panel, a User 1002 is shown sitting at a desk with a smartphone Device 1004 in hand. This representation may depict a typical user environment where natural language interactions with devices may occur. Above the user, a speech bubble labeled “Natural Language Input 1006” contains the text “Send a text to Mom saying I'll be late for dinner.” This speech bubble may represent the user's verbal command or typed input to the device, illustrating how natural language may be used to initiate complex tasks. The specific wording of the command may demonstrate the system's ability to interpret colloquial language and personal references, such as “Mom” instead of a formal contact name. In some scenarios, the system may be capable of handling various phrasings of the same request, such as “Text Mom that I won't make it to dinner on time” or “Let my mother know I'm running late for our meal,” potentially further illustrating its flexibility in natural language understanding.

The top-right panel displays a simplified representation of the LLM processing the request. A large rectangle labeled “Large Language Model (LLM) 1008” contains three smaller rectangles representing the steps: “Step 1: Open messaging app 1010,” “Step 2: Select contact ‘Mom’ 1012,” and “Step 3: Type and send message 1014.” Arrows connect these steps in sequence. This visual representation may illustrate how the LLM breaks down the user's natural language input into discrete, actionable steps. The sequencing of these steps may demonstrate the LLM's understanding of the logical order of operations used to complete the task. The simplification of complex actions into these three steps may show the LLM's ability to abstract high-level user intentions into specific device operations. Each step may correspond to a distinct action that the device will perform, bridging the gap between the user's natural language request and the technical operations of the device. In some implementations, the LLM may consider multiple potential action sequences and select the most efficient or appropriate one based on factors such as the device's current state, user preferences, and/or past interaction patterns.

The middle-left panel illustrates the Device 1004 screen showing the messaging app opening. A stylized Hand 1016 is touching the messaging app icon. This representation may depict the system's ability to interact with the device's user interface, simulating human touch inputs. The hand's positioning on the app icon may indicate precise control over the device's touchscreen interface. In the top-right corner, a small rectangle labeled “UI Layout 1018” contains a simplified representation of the current screen layout. This UI Layout 1018 element may represent the system's real-time understanding of the device's interface, which may be helpful for navigation and interaction. The simplified nature of this layout representation may suggest a data-efficient method of capturing and processing UI information. The presence of this UI Layout 1018 in the corner of the panel may indicate that this information is continuously monitored and updated throughout the task execution process. In some scenarios, the system may use this UI layout information to adapt to unexpected changes in the interface, such as pop-up notifications or app updates that may alter the usual navigation path.

The middle-right panel shows the Device 1004 screen with a list of contacts. Hand 1016 is selecting “Mom” from the list. This visualization may demonstrate the system's ability to navigate through different screens and menus within an application. The selection of “Mom” from the contact list may show the system's capability to match the user's natural language reference (“Mom”) with the corresponding entry in the device's contact list. This may involve natural language processing techniques to handle variations in contact names and nicknames. The UI Layout 1018 rectangle in the top-right corner is updated to reflect the current screen. This update may illustrate the dynamic nature of the UI layout capture process, adapting to each new screen as the task progresses.

The bottom-left panel displays the Device 1004 screen with an open message to “Mom” and the text “I'll be late for dinner” being typed. Hand 1016 is pressing the send button. This visualization may illustrate the system's ability to input text and interact with messaging interfaces, simulating human typing and button pressing. The exact replication of the user's intended message may demonstrate the system's accuracy in translating natural language commands into specific actions. The UI Layout 1018 rectangle is updated for this screen, potentially showing a different layout that represents the message composition interface. This continual updating of the UI Layout 1018 may emphasize the system's adaptability to various interface states within the same application. The representation of the send button being pressed may indicate the system's capability to complete the full cycle of message composition and sending, mirroring the actions a human user would take. In some scenarios, the system may also handle additional steps not explicitly shown, such as reviewing the message for accuracy, managing autocorrect functions, and/or handling any network-related issues that might arise during the sending process.

The bottom-right panel shows User 1002 smiling, with Device 1004 displaying a “Message Sent” confirmation. This visual feedback may represent the successful completion of the task and the system's ability to provide clear confirmation to the user. A large checkmark labeled “Goal Completed 1020” is also shown, which may further emphasize the successful execution of the user's request.

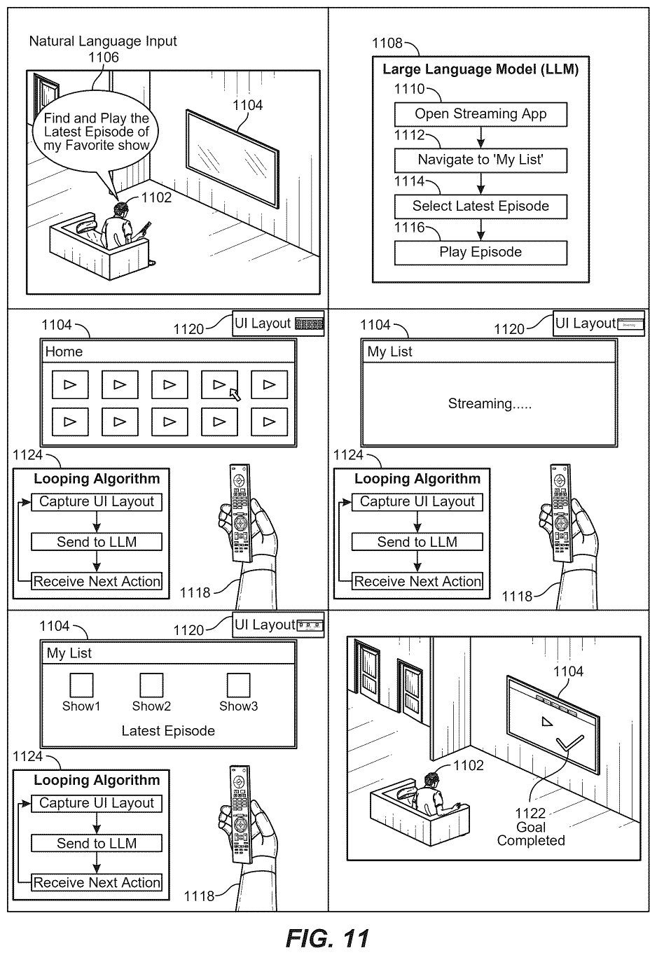

FIG. 11 illustrates an example sequence of panels depicting a natural language prompt execution for finding and playing a TV show episode. In the top-left panel, a User 1102 is shown looking at a smart TV Device 1104. This representation may depict a common home entertainment scenario where natural language interactions with devices may occur. Above the user, a speech bubble labeled “Natural Language Input 1106” contains the text “Find and play the latest episode of my favorite show.” This speech bubble may represent the user's verbal command to the device, showing how natural language may be used to initiate complex entertainment-related tasks. The specific wording of the command may demonstrate the system's ability to interpret subjective terms like “favorite show” and temporal references such as “latest episode,” potentially indicating advanced contextual understanding capabilities. In some scenarios, the system may be able to handle various phrasings of the same request, such as “Play the newest episode of the series I watch most” or “Start the most recent installment of my top program,” potentially showing its flexibility in natural language comprehension within the entertainment domain.

The top-right panel displays a simplified representation of the LLM processing the request. A large rectangle labeled “Large Language Model (LLM) 1108” contains four smaller rectangles representing the steps: “Step 1: Open streaming app 1110,” “Step 2: Navigate to ‘My List’ 1112,” “Step 3: Select latest episode 1114,” and “Step 4: Play episode 1116.” Arrows connect these steps in sequence. This visual representation may illustrate how the LLM breaks down the user's natural language input into discrete, actionable steps specific to interacting with a smart TV and streaming service. The sequencing of these steps may demonstrate the LLM's understanding of the logical order of operations used to complete the task within a streaming app environment. The inclusion of four steps, as opposed to three in the previous example, may show the LLM's ability to handle more complex, multi-stage tasks that involve navigating through various levels of a user interface. Each step may correspond to a distinct action that the smart TV will need to perform, bridging the gap between the user's natural language request and the technical operations of the streaming platform. In some implementations, the LLM may consider multiple potential action sequences and select the most efficient or appropriate one based on factors such as the specific streaming service being used, user viewing history, and/or personalized content recommendations.

The middle-left panel illustrates the Device 1104 screen showing the home menu of the smart TV. A stylized Hand 1118 is holding a remote control and selecting the streaming app icon. This representation may depict the system's ability to interact with the smart TV's user interface, simulating human remote control inputs. The hand's positioning on the remote may indicate precise control over the TV's interface, potentially showing the system's capability to navigate complex menu structures. In the top-right corner, a small rectangle labeled “UI Layout 1120” contains a simplified representation of the current screen layout. This UI Layout 1120 element may represent the system's real-time understanding of the TV's interface, which may be helpful for navigation and interaction in a less standardized environment like a smart TV platform. The simplified nature of this layout representation may suggest a data-efficient method of capturing and processing UI information specific to large-screen interfaces. The presence of this UI Layout 1120 in the corner of the panel may indicate that this information is continuously monitored and updated throughout the task execution process, even when dealing with varying screen sizes and resolutions typical of TV displays. In some scenarios, the system may use this UI layout information to adapt to unexpected changes in the interface, such as promotional overlays, system notifications, or app updates that may alter the usual navigation path on the smart TV platform.

The middle-right panel shows the Device 1104 screen with the streaming app open. Hand 1118 is using the remote control to navigate to the ‘My List’ section. This visualization may demonstrate the system's ability to navigate through different screens and menus within a streaming application, which may have a distinct interface from the smart TV's main menu. The navigation to the ‘My List’ section may show the system's capability to understand and interact with personalized content areas within streaming platforms. The UI Layout 1120 rectangle in the top-right corner is updated to reflect the current screen within the streaming app. This update may illustrate the dynamic nature of the UI layout capture process, adapting to each new screen as the task progresses, even within third-party applications running on the smart TV. The consistent presence of this UI Layout 1120 across panels may emphasize its importance in guiding the system's actions throughout the task execution, particularly in the context of a larger, more complex smart TV interface.

The bottom-left panel displays the Device 1104 screen showing a list of shows in the ‘My List’ section. Hand 1118 is using the remote to select the top show, labeled “Latest Episode.” This visualization may illustrate the system's ability to make selections within a content library, simulating human decision-making processes. The selection of the “Latest Episode” may demonstrate the system's capability to interpret and act upon the temporal aspect of the user's request (“latest episode”) within the context of the streaming platform. The UI Layout 1120 rectangle is updated for this screen, potentially showing a different layout that represents the content selection interface within the ‘My List’ section. This continual updating of the UI Layout 1120 may emphasize the system's adaptability to various interface states within the same application, which may be particularly helpful in streaming apps where content presentation can change frequently. The representation of the remote selecting the latest episode may indicate the system's capability to complete complex content discovery and selection tasks, mirroring the actions a human user would take when browsing their personalized content list.

The bottom-right panel shows User 1102 relaxing on a couch, with Device 1104 displaying the selected show playing. This visual feedback may represent the successful completion of the task and the system's ability to provide the requested entertainment content. A large checkmark labeled “Goal Completed 1122” is also shown, which may further emphasize the successful execution of the user's request. This panel may illustrate the result of user satisfaction in the natural language automation process, confirming that the system has correctly interpreted and executed the user's intention in the context of media consumption.

In some examples, the natural language-driven device automation system may employ various techniques to handle dynamic and changing user interfaces across different devices and applications. The system may utilize adaptive UI recognition algorithms that may dynamically adjust their parameters based on the current device state, operating system version, and/or application context. These algorithms may incorporate machine learning models trained on diverse UI datasets, potentially enabling them to recognize and adapt to novel interface elements or layouts. The system may also maintain a comprehensive database of UI patterns and elements across various devices and applications, which may be continuously updated through crowd-sourced data or automated crawling techniques. This database may serve as a reference point for the system to identify and interact with UI elements, even in unfamiliar or updated interfaces. Additionally, the system may implement a modular architecture with device-specific plugins or adapters, allowing for easy extension to new device types and/or rapid adaptation to OS updates or new hardware features. In some scenarios, the system may utilize a combination of visual analysis and accessibility API data to build a more robust understanding of the UI structure, potentially enhancing its ability to navigate through complex or non-standard interfaces. The system may also incorporate fuzzy matching algorithms to handle minor variations in UI element appearance or positioning, allowing for more flexible and resilient automation scripts. Furthermore, the system may implement a real-time UI diff analysis, comparing the current interface state with previously encountered layouts to identify changes and adjust its interaction strategy accordingly. This technique may be particularly helpful in handling dynamic elements such as pop-ups, loading screens, or context-sensitive menus that may appear during task execution. In some implementations, the system may also leverage natural language processing techniques to interpret textual content within the UI, potentially enabling it to navigate based on semantic understanding rather than relying solely on visual or structural cues. This technique may be particularly helpful when dealing with localized interfaces or applications with frequently changing content.

In some examples, the natural language-driven device automation system may implement various error handling and recovery mechanisms to enhance its robustness and reliability. The system may employ a multi-tiered error detection technique that may analyze UI states, system responses, and/or execution timelines to identify potential issues at different levels of granularity. This technique may involve maintaining a rolling buffer of recent actions and their outcomes, allowing the system to quickly identify and respond to unexpected results or deviations from the expected execution path. The system may also utilize predictive error modeling, leveraging machine learning algorithms to anticipate potential failure points based on historical data and/or current system states. In cases where errors are detected, the system may implement a graduated response strategy, potentially starting with minor adjustments to its current action plan and escalating to more significant interventions if initial recovery attempts are unsuccessful. This strategy may include techniques such as action repetition with varying parameters, alternative navigation paths, and/or dynamic reformulation of sub-goals to achieve the overall task objective. Additionally, the system may incorporate a distributed error handling technique, where different components of the system may have specialized error recovery capabilities tailored to their specific functions. For instance, the UI interaction module may have strategies for dealing with unresponsive elements or unexpected pop-ups, while the natural language processing component may have methods for clarifying ambiguous user inputs. The system may also implement timeout procedures that may be dynamically adjusted based on the complexity of the current task, system performance metrics, and/or learned patterns from previous executions. These timeout mechanisms may help prevent the system from becoming stuck in unproductive loops and/or may trigger appropriate fallback behaviors. In some scenarios, the system may employ a hierarchical rollback mechanism, allowing it to revert to previous known-good states at various levels of granularity, from individual actions to entire subtasks. This technique may be particularly helpful in complex, multi-step processes where errors in later stages may invalidate earlier progress. Furthermore, the system may include user intervention protocols that may be activated when automated recovery attempts are exhausted and/or when certain predefined error thresholds are exceeded. These protocols may involve generating clear, context-aware prompts for user guidance, potentially including suggested corrective actions and/or relevant diagnostic information.

In some examples, the natural language-driven device automation system may employ various compression techniques for UI layouts to optimize processing and storage. The system may utilize adaptive compression algorithms that dynamically adjust their parameters based on the complexity of the UI, available system resources, and/or the specific requirements of subsequent analysis steps. These algorithms may incorporate both lossless and lossy compression methods, potentially selecting the most appropriate technique based on the nature of the UI elements and the desired balance between compression ratio and fidelity. For instance, textual elements within the UI may be compressed using advanced text compression algorithms such as context-mixing or prediction by partial matching, while graphical elements may undergo image compression techniques like wavelet transforms or vector quantization. The system may also implement a hierarchical compression scheme, where different levels of the UI structure may be compressed at varying rates and/or using different algorithms. This technique may allow for more efficient storage and transmission of UI data while preserving the most relevant information for automation tasks. Additionally, the system may utilize semantic compression techniques that leverage understanding of UI structures and common patterns to achieve higher compression ratios. This may involve encoding frequently encountered UI elements or layouts using a predefined dictionary or generating compact representations based on the semantic meaning of UI components rather than their raw visual data. In some scenarios, the system may employ differential compression, storing and transmitting only the changes between successive UI states rather than complete layouts. This technique may be particularly helpful in reducing data volume during extended automation sequences where only portions of the UI may change between steps. The compression subsystem may also incorporate machine learning models trained on large datasets of UI layouts to identify and exploit recurring patterns or structures, potentially enabling more efficient compression of commonly encountered interface elements. Furthermore, the system may implement adaptive streaming of compressed UI data, prioritizing the transmission and decompression of elements most relevant to the current automation task. This technique may help reduce latency in distributed systems where UI data may be processed on remote servers and/or where bandwidth constraints may impact system responsiveness.

In some examples, the natural language-driven device automation system may integrate with various device types and operating systems to provide a seamless automation experience across diverse platforms. The system may employ a modular architecture that allows for easy extension to new device types, potentially including mobile devices, desktop computers, smart TVs, wearables, and/or IoT devices. This modular design may incorporate device-specific adapters or plugins that handle low-level interactions with each device type, while maintaining a common core for natural language processing and task planning. The system may utilize cross-platform frameworks and/or APIs that abstract away device-specific details, allowing for consistent automation logic across different operating systems and hardware configurations. In some scenarios, the system may implement a virtualization layer that emulates a standardized device interface, potentially enabling the automation logic to run unchanged across diverse devices. Additionally, the system may employ adaptive UI interaction techniques that dynamically adjust to different screen sizes, input methods, and/or interface paradigms. This adaptability may extend to handling various accessibility features and/or alternative input/output mechanisms, such as screen readers, voice commands, and/or gesture-based interfaces. The system may also incorporate device fingerprinting techniques to identify and adapt to specific device models and/or OS versions, potentially optimizing its performance for each unique configuration. In some implementations, the system may utilize a distributed architecture where certain components, such as heavy computational tasks or large language models, may run on cloud infrastructure while device-specific operations are executed locally. This hybrid technique may allow for efficient resource utilization across a range of device capabilities. Furthermore, the system may implement a sync mechanism that maintains consistent user preferences, automation scripts, and/or learned behaviors across multiple devices, potentially enabling seamless transitions between different platforms. The system may also adapt its natural language processing and task execution strategies based on the specific capabilities and limitations of each device type, such as adjusting for limited processing power on wearables and/or leveraging advanced sensors on smartphones.

In some examples, the natural language-driven device automation system may incorporate one or more of various learning and memory mechanisms to improve efficiency over time. The system may employ a multi-faceted learning technique that uses or combines one or more of several AI and/or machine learning methodologies to continuously enhance its performance. One such technique may involve the use of reinforcement learning algorithms, where the system may receive feedback on the success or failure of its actions and adjust its decision-making processes accordingly. This reinforcement learning technique may be implemented using advanced algorithms such as Deep Q-Networks or Proximal Policy Optimization, potentially allowing the system to improve its strategies for complex, multi-step tasks. Additionally, the system may utilize transfer learning techniques to apply knowledge gained from one type of task or device to new, similar scenarios, potentially reducing the learning curve for novel automation challenges. The memory component of the system may be structured as a hierarchical knowledge base, potentially incorporating both declarative and procedural knowledge about devices, applications, and user preferences. This knowledge base may be continuously updated through various means, including direct user feedback, automated performance analysis, and/or aggregated data from multiple users (with appropriate privacy safeguards). The system may also implement a form of episodic memory, storing detailed records of past automation sequences and their outcomes. This episodic memory may be used to inform future decision-making, potentially allowing the system to anticipate and preemptively address challenges it has encountered in similar situations. Furthermore, the system may employ meta-learning techniques, essentially learning how to learn more efficiently over time. This may involve dynamically adjusting its learning rate, exploration vs. exploitation balance, and/or feature extraction methods based on its cumulative experience across various tasks and domains.

In some examples, the natural language-driven device automation system may employ a wide array of natural language processing techniques to interpret diverse user inputs. The system may utilize advanced parsing algorithms that go beyond simple keyword matching, potentially incorporating deep learning models such as transformers or recurrent neural networks to capture the nuanced meaning and context of user commands. These models may be pre-trained on large corpora of text and fine-tuned on domain-specific datasets to enhance their understanding of device-related terminology and common user intents. The system may also implement multi-lingual support, allowing users to interact with devices in their preferred language. This may involve the use of neural machine translation models or cross-lingual embeddings to map user inputs from various languages to a common semantic space for processing. Additionally, the system may employ intent recognition techniques that leverage both rule-based systems and machine learning classifiers to accurately categorize user requests into predefined or dynamically generated intent categories. To handle ambiguity and vagueness in natural language inputs, the system may utilize fuzzy logic or probabilistic reasoning techniques, potentially assigning confidence scores to different interpretations of a user's request. The natural language processing component may also incorporate anaphora resolution and coreference resolution algorithms to maintain context across multiple user interactions, allowing for more natural, conversational interactions with the automation system. Furthermore, the system may implement named entity recognition and relationship extraction techniques to identify specific devices, applications, and/or settings mentioned in user commands, potentially enhancing its ability to execute complex, multi-step tasks involving multiple system components. To handle domain-specific jargon and technical terminology, the system may maintain and continuously update a specialized lexicon, potentially using techniques like automatic term extraction from relevant corpora and/or active learning from user interactions.

In some examples, the natural language-driven device automation system may implement a codeless technique that enables users to create and execute complex automation tasks without writing programming code in the manner of related systems. In other words, the system may intelligently translate natural language commands into UI input commands themselves, consistent with FIG. 1 and the discussions above, as distinct from generating code itself to achieve the outcome. In this sense, the combination of natural language prompting and UI command generation may be distinguished from related or more traditional coding practices that specifically and directly generate program code (e.g., Python code, C++ code, etc.), rather than UI inputs, to achieve the desired outcome.

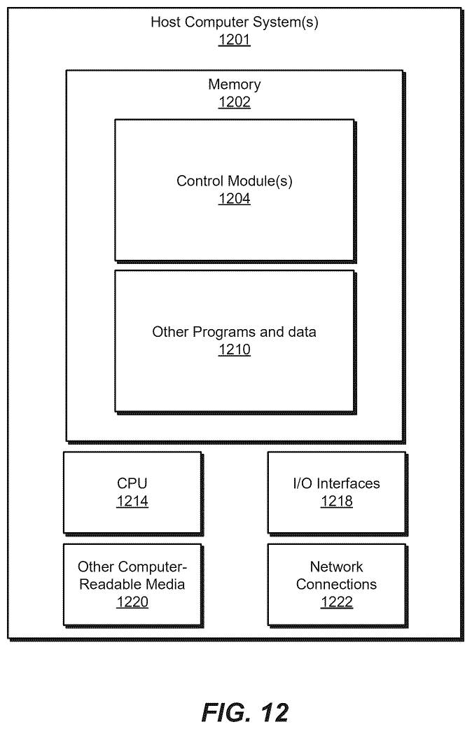

FIG. 12 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 12 illustrates an example of underlying hardware on which such software and functionality may be hosted and/or implemented.

In particular, shown is example host computer system(s) 1201. For example, such computer system(s) 1201 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1201 may include memory 1202, one or more central processing units (CPUs) 1214, I/O interfaces 1218, other computer-readable media 1220, and network connections 1222.

Memory 1202 may include one or more various types of non-volatile and/or volatile storage technologies. Examples of memory 1202 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1202 may be utilized to store information, including computer-readable instructions that are utilized by CPU 1214 to perform actions, including those of embodiments described herein.

Memory 1202 may have stored thereon control module(s) 1204. The control module(s) 1204 may be configured to implement and/or perform some or all of the functions of the systems or components described herein. Memory 1202 may also store other programs and data 1210, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1222 are configured to communicate with other computing devices to facilitate the functionality described herein. In various embodiments, the network connections 1222 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1218 may include a video interface, other data input or output interfaces, or the like. Other computer-readable media 1220 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, through a software automation tool, a natural language input from a user describing a goal that the user seeks to accomplish on a computing device;
dividing, by the software automation tool in response to receiving the natural language input from the user, the goal into a sequence of plural steps that the software automation tool predicts would achieve the goal;
performing, for each respective step of the sequence of plural steps in sequential order, a looping algorithm that provides an iterative capture of a current user interface (UI) layout of the computing device to a large language model (LLM) in a loop until the respective step is completed; and
outputting, through the software automation tool to the user and based on performing the looping algorithm for each respective step of the sequence of plural steps in sequential order, an indication that the goal has been achieved for the user in response to receiving the natural language input.

2. The method of claim 1, wherein the looping algorithm comprises:
setting a next action as the respective step;
attempting, as an attempt operation, to perform the next action;
capturing, as a capturing operation in response to attempting to perform the next action, the current UI layout of the computing device;
providing, as a providing operation, the current UI layout to the LLM;
receiving, as a receiving operation, from the LLM, an indication that the next action succeeded or that the next action failed such that a new intervening troubleshooting action should be performed; and
repeating, if the LLM indicates that the next action failed, the attempt operation, the capturing operation, the providing operation, and the receiving operation using the new intervening troubleshooting action as the next action until the LLM indicates that the respective step succeeded.

3. The method of claim 2, wherein the providing operation comprises compressing the current UI layout such that a compressed UI layout is provided to the LLM.

4. The method of claim 2, wherein dividing the goal into the sequence of plural steps is performed by the LLM.

5. The method of claim 2, further comprising updating a memory of the LLM based on successful completion of the goal such that the LLM learns from a previous interaction.

6. The method of claim 2, wherein the next action comprises, for at least one iteration, a series of plural actions for execution in series or parallel without intervening feedback between any two of the plural actions.

7. The method of claim 2, wherein the capturing operation comprises applying a UI automation framework such that structured text representing the UI layout is extracted.

8. The method of claim 2, wherein attempting to perform the next action comprises simulating user input on the computing device.

9. The method of claim 2, wherein the looping algorithm further comprises verifying that the current UI layout has changed before providing the current UI layout to the LLM.

10. The method of claim 2, further comprising capturing and processing an image of the current UI layout if the looping algorithm fails to progress after a predetermined number of iterations.

11. The method of claim 1, wherein the computing device comprises a mobile device, a desktop computer, a smart TV, or a wearable device.

12. The method of claim 1, further comprising initiating a timeout procedure if the looping algorithm exceeds a predetermined duration or a predetermined number of iterations for a particular operation.

13. The method of claim 1, further comprising:
detecting that the looping algorithm is stuck at a current step; and
requesting, in response to detecting that the looping algorithm is stuck at the current step, user guidance for completing the current step.

14. The method of claim 1, further comprising generating a report detailing the sequence of plural steps performed or at least one error encountered during execution of the sequence of plural steps.

15. The method of claim 1, further comprising:
receiving the natural language input as a voice command; and
converting the voice command into text before dividing the goal into the sequence of plural steps.

16. The method of claim 1, wherein:
the method further comprises maintaining a database of previously executed goals and their corresponding sequences of plural steps; and
dividing the goal into the sequence of plural steps is performed at least in part by referencing the database such that efficiency is improved.

17. A non-transitory computer-readable medium that has instructions stored thereon that, when executed by at least one physical computing processor, cause a computing device to perform operations comprising:
receiving, through a software automation tool, a natural language input from a user describing a goal that the user seeks to accomplish on a computing device;
dividing, by the software automation tool in response to receiving the natural language input from the user, the goal into a sequence of plural steps that the software automation tool predicts would achieve the goal;
performing, for each respective step of the sequence of plural steps in sequential order, a looping algorithm that provides an iterative capture of a current user interface (UI) layout of the computing device to a large language model (LLM) in a loop until the respective step is completed; and
outputting, through the software automation tool to the user and based on performing the looping algorithm for each respective step of the sequence of plural steps in sequential order, an indication that the goal has been achieved for the user in response to receiving the natural language input.

18. The non-transitory computer-readable medium of claim 17, wherein the computing device comprises a mobile device, a desktop computer, a smart TV, or a wearable device.

19. A system comprising:
at least one physical computing processor of a computing device; and
a non-transitory computer-readable medium that has instructions stored thereon that, when executed by the at least one physical computing processor, cause the computing device to perform operations comprising:
receiving, through a software automation tool, a natural language input from a user describing a goal that the user seeks to accomplish on a computing device;
dividing, by the software automation tool in response to receiving the natural language input from the user, the goal into a sequence of plural steps that the software automation tool predicts would achieve the goal;
performing, for each respective step of the sequence of plural steps in sequential order, a looping algorithm that provides an iterative capture of a current user interface (UI) layout of the computing device to a large language model (LLM) in a loop until the respective step is completed; and
outputting, through the software automation tool to the user and based on performing the looping algorithm for each respective step of the sequence of plural steps in sequential order, an indication that the goal has been achieved for the user in response to receiving the natural language input.

20. The system of claim 19, wherein the computing device comprises a mobile device, a desktop computer, a smart TV, or a wearable device.
